(19) United States
(12) Patent Application Publication
(10) Pub. No.: US 2025/0238393 A1
(43) Pub. Date: Jul. 24, 2025

(54) RESPONDER SUBSCRIBER STATION FOR A SERIAL BUS SYSTEM, COMMANDER SUBSCRIBER STATION FOR THE SERIAL BUS SYSTEM, AND METHOD FOR COMMUNICATION IN A SERIAL BUS SYSTEM

(71) Applicant: Robert Bosch GmbH, Stuttgart (DE)

(72) Inventors: Arthur Mutter, Neuhausen (DE); Steffen Walker, Reutlingen (DE)

(21) Appl. No.: 18/985,172

(22) Filed: Dec. 18, 2024

(30) Foreign Application Priority Data
Jan. 19, 2024 (DE) 10 2024 200 489.8

(51) Int. Cl. G06F 13/42; G06F 13/40

(52) U.S. Cl. CPC G06F 13/4295; G06F 13/4022

(57) ABSTRACT

A responder subscriber station for a serial bus system, a commander subscriber station, and a method for communication. The responder subscriber station has a communication control device for controlling communication of the subscriber station with a commander subscriber station and for evaluating at least one signal, received from a bus of the bus system, based on a predetermined frame, wherein a field can be present in the frame for switching a first bit time and a first physical layer in a first communication phase to a second bit time and a second physical layer in a second communication phase, and a synchronization module. The synchronization module is designed to switch off its synchronization function if the communication control device is to act as a transmitter of the frame, so that the responder subscriber station is the transmitter of the signal received from the bus.

### CROSS REFERENCE

The present application claims the benefit under 35 U.S.C. § 119 of German Patent Application No. DE 10 2024 200 489.8 filed on Jan. 19, 2024, which is expressly incorporated herein by reference in its entirety.

### FIELD

The present invention relates to a responder subscriber station for a serial bus system, a commander subscriber station for the serial bus system, and a method for communication in a serial bus system.

### BACKGROUND INFORMATION

Bus systems are used in many fields of technology for communication between technical devices, such as sensors and controllers.

As is conventional, Classical CAN and/or CAN FD, which are both standardized in the international standard ISO 11898-1:2015, are used for communication between devices in vehicles and/or in other technical devices. With CAN FD, communication on the bus is possible at, for example, 2 Mbit/s or 5 Mbit/s. 64 bytes can be sent per message on the bus.

CAN XL, which is compatible with CAN FD and is specified in ISO/DIS 11898-1:2023, can also be used. With CAN XL, communication on the bus is possible at bit rates of up to 20 Mbit/s and with a data volume of up to 2048 bytes per message.

The subscriber stations of such a bus system are also called nodes. Such subscriber stations have a microcontroller that supports all functions of the aforementioned standards for Classical CAN and/or CAN FD and/or CAN XL in CAN XL.

CAN XL offers the great advantage that data can be exchanged between subscriber stations of the bus system at a significantly higher speed than with Classical CAN or CAN FD. However, the requirements for communication devices for carrying out communication with CAN XL and thus their costs are higher than for communication devices designed only for Classical CAN and/or CAN FD.

The cost aspect is particularly disadvantageous in relation to subscriber stations that only have to carry out very simple function(s). Such subscriber stations are, for example, an indicator light, in particular a light-emitting diode (LED), which is to be switched on or off and/or to change its color as required under the control of the microcontroller of another subscriber station. Another example is a sensor that is to deliver its detection data from time to time to the microcontroller of another subscriber station.

Therefore, there is a desire to use the advantages of CAN XL for communication at lower costs. For this purpose, it is being considered to equip such subscriber stations for carrying out such simple functions in a bus system with a smaller communication scope than others. However, due to the complexity of CAN XL, this is not easily possible.

It would be possible to design such subscriber stations for carrying out such simple functions as responders that are assigned to a commander and can only communicate with this commander. A subscriber station that has a microcontroller for controlling the responder is also referred to as a commander. However, communication devices for such responder subscriber stations and commander subscriber stations for CAN XL are not yet available.

### SUMMARY

It is an object of the present invention to provide a responder subscriber station for a serial bus system, a commander subscriber station for a serial bus system, and a method for communication in a serial bus system that solve the aforementioned problems. To be provided in particular are a responder subscriber station for a serial bus system, a commander subscriber station for a serial bus system, and a method for communication in a serial bus system with which communication in the serial bus system with a high degree of error robustness and at a higher bit rate than before and a high net data transmission rate is possible.

This object may be achieved by a responder subscriber station for a serial bus system having certain features of the present invention. According to an example embodiment of the present invention, the responder subscriber station has a communication control device for controlling communication between the subscriber station and a commander subscriber station of the bus system and for evaluating at least one signal, received from a bus of the bus system, based on a predetermined frame, with which the bit time in a first communication phase can differ from a bit time in a second communication phase, wherein a field can be present in the frame for switching the first bit time and a first physical layer in a first communication phase to a second bit time and a second physical layer in a second communication phase, and a synchronization module for synchronizing the communication control device to the signal received from the bus, wherein the synchronization module is designed to switch off its synchronization function if the communication control device is to act as a transmitter of the frame, so that the responder subscriber station is the transmitter of the signal received from the bus.

The described subscriber station (responder) of the present invention has a simplified CAN XL controller, as a result of which a cost-effective integration of the responder on a single ASIC in a mixed semiconductor process, such as bipolar transistor(s) and CMOS transistor(s) and DMOS transistor(s) (BCD technology), is possible. After a transmission request by the commander, the responder subscriber station (responder) transmits its function information, for example a sensor value, etc., with a CAN XL message to the commander subscriber station (commander).

The described responder subscriber station of the present invention can be used for CAN XL Light communication with a commander subscriber station at bit rates that are higher than the currently possible bit rates with CAN FD. In particular, the bit rates are greater than 10 Mbit/s, in particular up to 20 Mbit/s. This means that significantly higher bit rates are possible with the responder subscriber station than with CAN FD Light, with which only 2 Mbit/s or 5 Mbit/s can be achieved.

In addition, with the described responder subscriber station of the present invention, significantly larger data packets, namely 2 kbytes, can be transmitted per message over the bus than with CAN FD Light, with which only 64 bytes are permitted.

A very great advantage of the described responder subscriber station of the present invention is greatly reduced costs at the system level. One reason for this is that there is no need for a highly accurate clock in the responder subscriber station, since no arbitration is necessary. The clock can be up to 5 times less accurate than with CAN XL. Another reason for the greatly reduced costs is that a protocol controller with a significantly reduced range of functions can be used in the responder subscriber station, which makes savings of approximately 50% possible. Yet another reason for the greatly reduced costs is that no changes to the CAN XL transmitting/receiving device (transceiver) or CAN SIC XL transmitting/receiving device (transceiver) in the responder subscriber station are required. This means that the described responder subscriber station can use the CAN SIC XL transmitting/receiving device (transceiver), which is specified for CAN XL according to the international standard ISO/DIS 11898-2:2023, for bit rates of up to 20 Mbit/s.

It is additionally advantageous that, depending on the operating mode, an existing CAN controller that is specified for CAN XL according to the international standard ISO/DIS 11898-1:2023 and ISO/DIS 11898-2:2023 can also be used for a commander subscriber station with the described responder subscriber station.

Overall, the subscriber station described helps to make the bus system more cost-effective with data rates of up to 20 Mbit/s and data packets of approximately 2 kbyte in one message but still makes robust and reliable CAN communication possible.

Advantageous further example embodiments of the subscriber station of the present invention are disclosed herein.

In a variant of the present invention, the synchronization module is designed to switch off its synchronization function if the bit time of the first communication phase of the predetermined frame has a predetermined value corresponding to a bit rate that is greater than a predetermined bit rate and if the communication control device is to act as a transmitter of the frame, so that the responder subscriber station is the transmitter of the signal received from the bus.

In one example embodiment of the present invention, the synchronization module has a synchronization block that is designed for synchronizing the communication control device to the signal received from the bus, and a configuration block in which a value for at least one synchronization configuration bit is stored, which value indicates whether the bit rate is greater than the predetermined bit rate.

The synchronization module may also have an evaluation block for evaluating the value of the at least one configuration bit, and a switching block for switching on or off the synchronization of the synchronization block on the basis of the evaluation of the evaluation block.

The responder subscriber station can be a subscriber station that is designed to communicate according to CAN XL, wherein the predetermined frame is a CAN XL frame in the XBFF format.

It is possible that the predetermined bit rate is 1 Mbit/s.

The aforementioned object may also achieved by a commander subscriber station for a serial bus system having certain features of the present invention. According to an example embodiment of the present invention, the commander subscriber station has a communication control device for controlling communication between the subscriber station and a responder subscriber station of the bus system and for evaluating at least one signal, received from a bus of the bus system, based on a predetermined frame with which the bit time in a first communication phase can differ from a bit time in a second communication phase, wherein a field can be present in the frame for switching a first physical layer in the first communication phase to a second physical layer in the second communication phase. The commander subscriber station also has a synchronization module for synchronizing the communication control device to the signal received from the bus, wherein the synchronization module is designed to switch off its synchronization function if the bit time of the first communication phase of the predetermined frame has a predetermined value corresponding to a bit rate that is greater than a predetermined bit rate and if the communication control device is to act as a transmitter of the predetermined frame, so that the commander subscriber station is the transmitter of the signal received from the bus.

According to an example embodiment of the present invention, the commander subscriber station described can support more than one frame format. Accordingly, the synchronization function of the commander subscriber station can be switched on or off, in particular by setting the value of a configuration bit, as mentioned above, for example. If synchronization is switched off, the commander subscriber station no longer supports arbitration and can therefore only be used as a commander.

However, if the synchronization function is switched on when transmitting, the commander subscriber station can also communicate and arbitrate with a normal CAN XL or CAN FD subscriber station on the bus.

Advantageous further embodiments of the subscriber station of the present invention are disclosed herein.

With the commander subscriber station described above, the synchronization module can have a synchronization block that is designed for synchronizing the communication control device to the signal received from the bus, and a configuration block in which a value for at least one synchronization configuration bit is stored, which value indicates whether the bit rate is greater than the predetermined bit rate.

In addition, the synchronization module of the commander subscriber station can have an evaluation block for evaluating the value of the at least one configuration bit, and a switching block for switching on or off the synchronization of the synchronization block on the basis of the evaluation of the evaluation block.

The commander subscriber station described above can be a CAN XL subscriber station, wherein the predetermined frame is a CAN XL frame in the XBFF format.

It is possible that, with the above-described commander subscriber station, the predetermined bit rate is 1 Mbit/s.

The above-described commander subscriber station and at least one above-described responder subscriber station can be part of a bus system that has a bus and at least two subscriber stations that are connected to one another via the bus in such a way that they can communicate with one another serially, wherein each of the at least two subscriber stations also has a transmitting/receiving device for transmitting a transmission signal to the bus of the bus system and/or for receiving a signal from the bus of the bus system.

According to an example embodiment of the present invention, the bus system can also have at least one third subscriber station that is designed for transmitting and/or receiving signals based on a frame, wherein the at least one third subscriber station has a communication control device, which is designed to negotiate with the commander subscriber station in a first communication phase of the frame whether the third subscriber station or the commander subscriber station will receive at least temporarily exclusive, collision-free access to the bus in a subsequent second communication phase.

The aforementioned object of the present invention is also achieved by a method for communication in a serial bus system according to the present invention. According to an example embodiment of the present invention, the method is carried out with an above-described commander subscriber station of the present invention and an above-described responder subscriber station of the present invention.

The method of the present invention offers the same advantages as those mentioned above in relation to the subscriber stations of the present invention.

With the method of the present invention, it is possible, in contrast to a CAN XL subscriber station, that the commander subscriber station and the responder subscriber station do not carry out bit monitoring when transmitting a message, that the commander subscriber station does not transmit an ACK bit if the commander subscriber station has correctly received a message, that the responder subscriber station does not transmit an ACK bit if the responder subscriber station has correctly received a message, that the responder subscriber station does not carry out error signaling, that the responder subscriber station does not use overload frames, that the responder subscriber station does not perform automatic re-transmission, and that the responder subscriber station does not perform automatic switching off of the responder subscriber station when detecting a predetermined number of communication errors.

Further possible implementations of the present invention also include combinations, even those not explicitly mentioned, of features or embodiments described above or below with respect to the exemplary embodiments of the present invention. In this case, a person skilled in the art will also add individual aspects as improvements or additions to the relevant basic form of the present invention.

### BRIEF DESCRIPTION OF THE DRAWINGS

The present invention is described in more detail below with reference to the figures and on the basis of exemplary embodiments.

FIG. 1 shows a simplified block diagram of a bus system according to a first exemplary embodiment of the present invention.

FIG. 2 shows the format of CAN FD frames according to the aforementioned standard ISO 11898-1:2015 for a message which can be transmitted from a transmitting/receiving device for a subscriber station of the bus system according to the first exemplary embodiment of the present invention.

FIG. 3 shows the format of a CAN XL frame according to the standard ISO/DIS 11898-1:2023 for a message that can be transmitted from a transmitting/receiving device for a subscriber station of the bus system according to the first exemplary embodiment as an alternative to the CAN FD frame of FIG. 2.

FIG. 4 shows a simplified schematic block diagram of a first subscriber station (commander) of the bus system according to the first exemplary embodiment of the present invention.

FIG. 5 shows a time profile of a digital transmission signal during operation of the bus system at the first subscriber station, which is connected to at least a second subscriber station on the same bus of the bus system.

FIG. 6 shows a time profile of bus signals CAN_H and CAN_L at the first subscriber station according to the first exemplary embodiment of the present invention.

FIG. 7 shows a time profile of a differential voltage VDIFF of the bus signals CAN_H and CAN_L at the first subscriber station according to the first exemplary embodiment of the present invention.

FIG. 8 shows a time profile of a digital reception signal that the first or a second subscriber station generates from a signal received from the bus, which signal is based on the transmission signal of FIG. 5, according to the present invention.

FIG. 9 shows an example of the ideal time profile of bus signals CAN_H, CAN_L, which are transmitted to a bus of the bus system by subscriber stations of the bus system for the message in FIG. 3, according to an example embodiment of the present invention.

FIG. 10 shows the time profile of a differential voltage VDIFF, which forms on the bus of the bus system as a result of the bus signals of FIG. 9, according to the present invention.

FIG. 11 shows an example of a time profile of a digital transmission signal, which is to be converted in an arbitration phase (SIC operating mode) into bus signals CAN_H, CAN_L for a bus of the bus system of FIG. 1, according to the present invention.

FIG. 12 shows the time profile of the bus signals CAN_H, CAN_L during switching from a recessive bus state to a dominant bus state and back to the recessive bus state, which bus signals are transmitted to the bus in the arbitration phase (SIC operating mode) due to the transmission signal of FIG. 5, according to the present invention.

FIG. 13 shows a simplified schematic block diagram of a second subscriber station (responder) of the bus system according to the first exemplary embodiment of the present invention.

In the figures, identical or functionally identical elements are given the same reference signs unless otherwise indicated.

### DETAILED DESCRIPTION OF EXAMPLE EMBODIMENTS

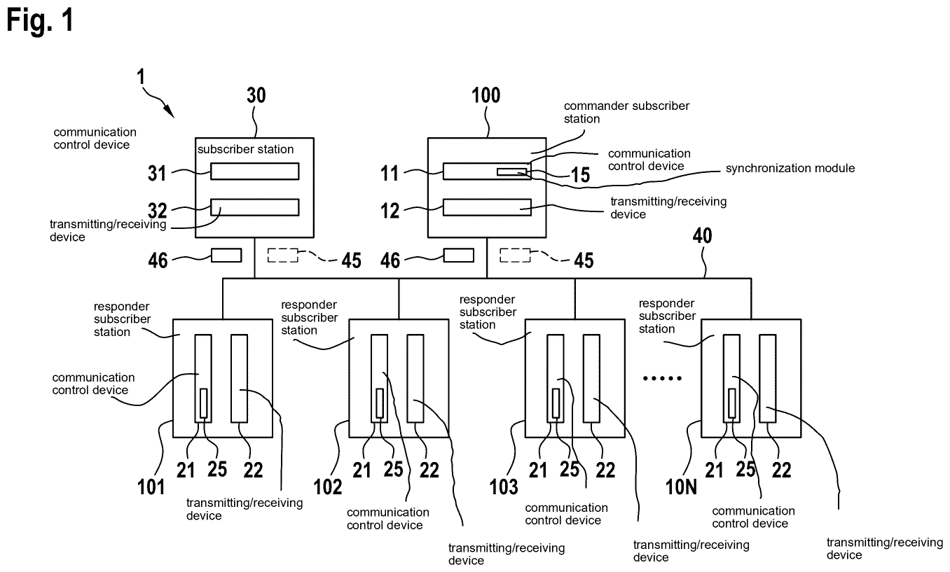

FIG. 1 shows an example of a bus system 1, which is in particular fundamentally designed for a CAN bus system, a CAN FD bus system, a CAN XL bus system, and/or modifications thereof, as described below. The bus system 1 can be used in a vehicle, in particular a motor vehicle, an aircraft, etc., or in a hospital, etc.

In FIG. 1, the bus system 1 has a bus 40 to which a commander subscriber station 100 and a plurality of responder subscriber station(s) 101, 102, 103 . . . 10N are connected. N is a natural number greater than or equal to 1. In addition, a subscriber station 30 is optionally connected, which can be a conventional Classical CAN subscriber station or a conventional CAN FD subscriber station or a conventional CAN XL subscriber station.

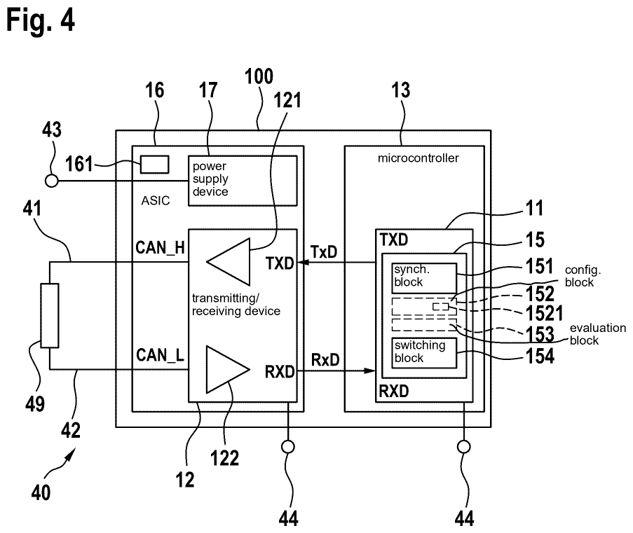

1 to N responder subscriber stations 101, 102, 103 . . . 10N are connected to the bus 40. The bus 40 can have a first bus wire 41 (FIG. 4) and a second bus wire 42 (FIG. 4), which are not shown in FIG. 1. The bus wires can also be referred to as CAN_H and CAN_L and are used for electrical signal transmission after the coupling-in of the dominant levels or generation of recessive levels or other levels for a signal in the transmission state.

The commander subscriber station 100 is, for example, a controller of a motor vehicle or other technical system, as described in more detail below. The responder subscriber stations 101, 102, 103 . . . 10N can, for example, have at least one sensor or at least one display device or at least one actuator or at least one transducer, etc. of a motor vehicle or other technical system, as described in more detail below.

As shown in FIG. 1, the commander subscriber station 100 has a communication control device 11, a transmitting/receiving device 12, and a synchronization module 15. Each of the responder subscriber stations 101, 102, 103 . . . 10N has a communication control device 21, a transmitting/receiving device 22, and a synchronization module 25. The at least one optional subscriber station 30 has a communication control device 31 and a transmitting/receiving device 32.

The transmitting/receiving devices 12, 22, 32 of the subscriber stations 100 . . . 10N and of the subscriber station 30 are each connected directly to the bus 40, even if this is not illustrated in FIG. 1.

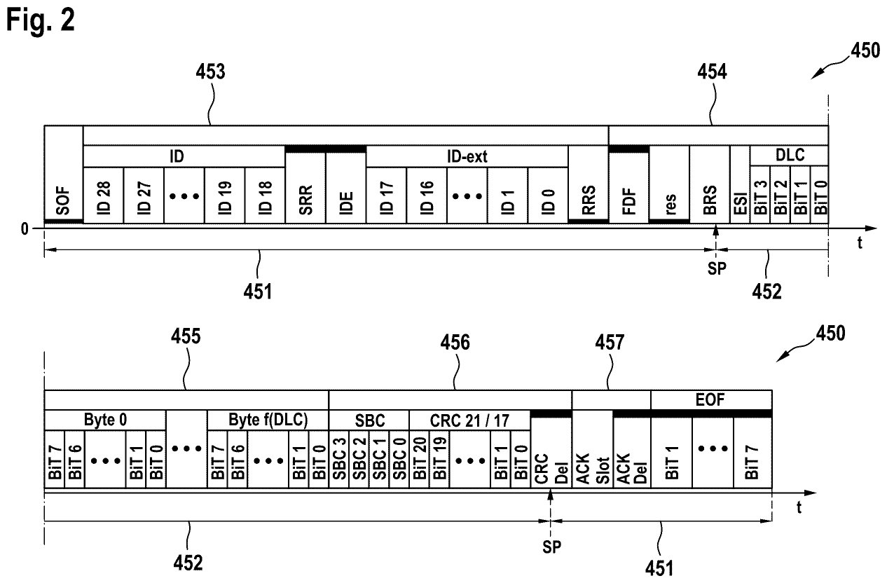

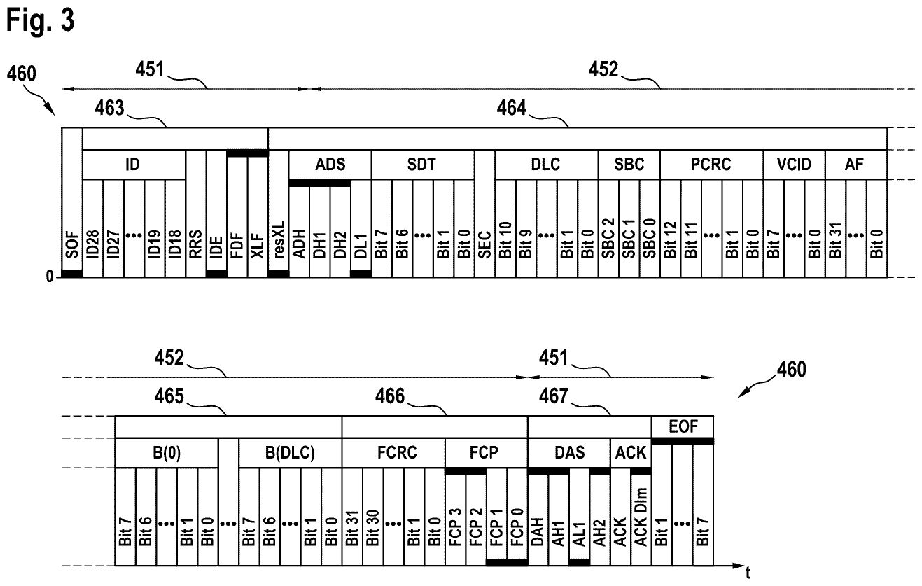

The commander subscriber station 100 is designed to create messages 45, 46 in the form of signals. However, the commander subscriber station 100 is designed to transmit only messages 46 in the form of signals to one of the subscriber stations 101 . . . 10N via the bus 40. The message 46 is partially constructed in the same way as a message 45, as described in more detail with reference to FIG. 2 and FIG. 3.

The subscriber stations 101 . . . 10N in FIG. 1 are designed to create messages 46 in the form of signals and to transmit them to the commander subscriber station 100 via the bus 40. The messages 46 can be transmitted serially between the subscriber station 100 and one of the subscriber stations 101 to 10N.

The at least one optional subscriber station 30 is designed to create messages 45, 46 in such a way that communication with the commander subscriber station 100 is possible via the bus 40. However, the communication is designed such that the at least one optional subscriber station 30 does not interfere with the communication between responder subscriber stations 101, 102, 103 . . . 10N and commander subscriber station 100. This can be done in different ways, A) with the aid of a timing adjustment, or B) by selecting appropriate identifiers so that the optional subscriber station 30 always loses an arbitration with a responder subscriber station 101, 102, 103 . . . 10N. This is described in more detail below.

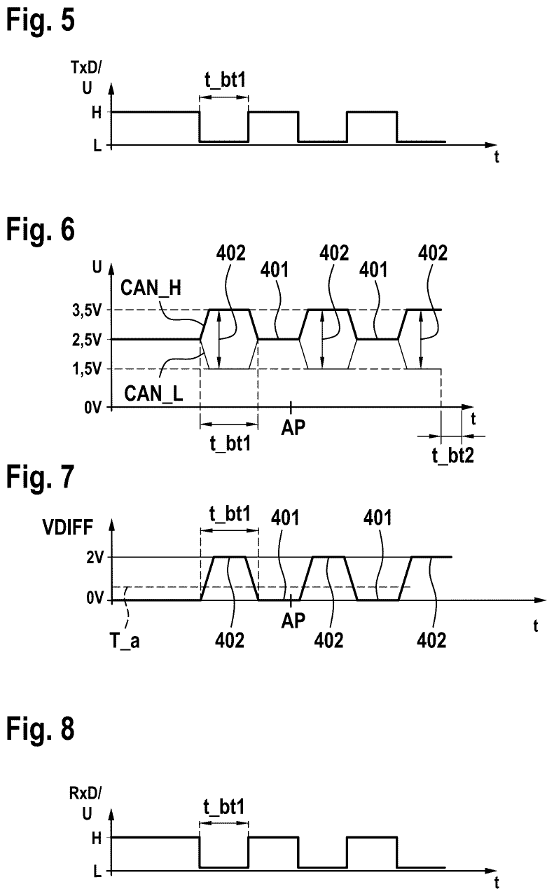

The communication control devices 11, 21 are each used for controlling communication of the subscriber station 100 with one of the subscriber stations 101 . . . 10N via the bus 40. When necessary, the communication control devices 11, 21 create a transmission signal TxD, which is described in more detail below with reference to FIG. 5. In addition, the communication control devices 11, 21, 31 read or decode a reception signal RxD, which is described in more detail below with reference to FIG. 8.

The communication control device 11 can, at least partially, be designed like a conventional CAN XL controller according to ISO/DIS 11898-1:2023. Thus, the communication control device 11 supports the transmission and/or reception of 7 different frame formats, namely 4 Classical CAN frame formats, 2 CAN FD frame formats having 11-bit or 29-bit identifiers, and 1 CAN XL frame format.

The communication control device 31 can be designed like a conventional CAN XL controller according to ISO/DIS 11898-1:2023. Therefore, the communication control devices 11, 31 can communicate with one another, as is customary with Classical CAN or CAN FD or CAN XL.

As an example, FIG. 2 shows a CAN FD frame 450 with 29-bit identifier, which the subscriber station 100 can use for communicating with the subscriber station 30 with messages 45 via the bus 40. In the case of the CAN FD messages 45, a number of 0 to 64 data bytes can be included, which are transmitted at a significantly faster data rate than in the case of a Classical CAN message.

The communication control device 11 of FIG. 1 is designed such that it uses a CAN XL message 46 for communicating with the subscriber station 101 . . . 101N. The particular synchronization modules 15, 25 are optionally used for transmitting and receiving the CAN XL message 46. The CAN XL message 46 is constructed on the basis of a CAN XL format, which is described in more detail with reference to FIG. 3. The synchronization modules 15, 25 are only required for bit rates greater than 1 Mbit/s.

The communication control device 11 thus creates and reads a first message 45 or a second message 46, wherein the first and second messages 45, 46 differ in their data transmission standard, namely in this case CAN FD and CAN XL.

The communication control device 21 is designed as a CAN XL Light controller. In addition, the synchronization module 25 is present, which is designed to be compatible with the synchronization module 15. The communication control device 21 creates second messages 46, for example CAN XL messages 46, and is designed to read messages 46.

For communicating with one of the subscriber stations 101 . . . 10N, the subscriber station 100 (commander) transmits a transmission request to the desired subscriber station 101 . . . 10N via the bus 40. The transmission request is carried out by transmitting a message 46 based on a CAN XL frame 460 shown in FIG. 3. A responder subscriber station 101 . . . 10N only transmits a message 46, which is based on a CAN XL frame according to FIG. 3, to the commander subscriber station 100 via the bus 40 if the subscriber station 100 has requested the subscriber station 101 . . . 10N to do so by means of a transmission request. The request for transmitting is encoded in the frame 460 transmitted by the subscriber station 100 (commander).

In the CAN XL Light bus access method, only the subscriber station 100 (commander) initiates communication with the responders. For this purpose, the subscriber station 100 (commander) transmits a message 46 in a frame according to FIG. 3. After completion of the message 46, the subscriber station 100 (commander) grants the responder a certain time window in which one of the N responder subscriber stations 101 . . . 10N can transmit a message 46 and thereby answer the transmission request.

Thus, the subscriber station 100 has the function of a commander/interrogator in relation to the subscriber stations 101 . . . 10N, and each of the subscriber stations 101 . . . 10N has the function of a responder. Therefore, the subscriber station 100 is also referred to as the CAN XL Light commander, and the subscriber station 101 . . . 10N is referred to as the CAN XL Light responder.

FIG. 2 shows an example of a frame 450 that can be created by the subscriber station 100 for a message 45 with up to 64 data bytes in the CAN FD FEFF format. The CAN FD frame 450 can be provided by the communication control device 11, namely encoded in a digital transmission signal TxD, for the associated transmitting/receiving device 12 for transmission to the bus 40 to another subscriber station of the bus system 1, for example the subscriber station 30.

The frame 450 is divided into two communication phases, which are called the arbitration phase 451 (first communication phase) and the data phase 452 (second communication phase). The frame 450 begins and ends in the arbitration phase 451. The frame 450 begins with an SOF bit and has an arbitration field 453, a control field 454, a data field 455, a checksum field 456 (CRC field), a confirmation field 457 (ACK=acknowledge), and a frame end field EOF (EOF=end of frame).

Bits in the arbitration phase 451 of the frame 450 possibly have a longer bit time than bits of the data phase 452, as illustrated in FIG. 2 by way of example. The switching from the bits with the bit time of the arbitration phase 451 to the bits with the bit time of the data phase 452 is carried out in the BRS bit, at the point marked SP in FIG. 2. SP stands for sample point.

Bits shown with a thick line on their lower line in FIG. 2 are transmitted in the frame 450 as dominant or ‘0.’ Bits shown with a thick line on their upper line in FIG. 2 are transmitted in the frame 450 as recessive or ‘1.’ Such bits, which are shown in FIG. 2 with a thick line, have a predetermined permanent or fixed value in the frame 450.

The arbitration field 453 contains an identifier of the frame 450, which is divided into the two fields ID field and ID-ext field. The identifier has 29 bits. An SRR bit and an IDE bit are provided between the ID field and the ID-ext field. An RRS bit is arranged at the end of the arbitration field 453. FIG. 2 shows the FEFF format with the 29-bit “extended identifier.” Alternatively, the commander subscriber station 100 or the optional subscriber station 30 can use a different CAN FD frame format, in particular a modified frame 450, which has an 11-bit identifier.

The control field 454 begins with an FDF bit, followed by a res bit. These are followed by the BRS bit and an ESI bit. The ESI bit is the first bit in the frame 450 with the bit time of the data phase 452.

The control field 454 ends with a DLC field in which the length of the following data field 455 is encoded. The res bit must be transmitted for the frame 450 with a logical value 0, in other words as (logical) 0, i.e., dominant.

The data field 455 will not be present if the DLC field of the control field 453 has the value 0. The data field 455 has a length corresponding to the value encoded in the DLC field. The value can be up to 64 bytes, as mentioned above.

The checksum field 456 contains in a field SBC the number of stuff bits modulo 8 which have been inserted into the frame 450 according to the bit stuffing rule, namely that following five identical bits, a bit inverse thereto is to be inserted in each case. In addition, the checksum field 456 in a CRC field contains a CRC checksum and, following this, ends with a CRC delimiter CRC-Del.

The switching from the bits with the bit time of the data phase 452 to the bits with the bit time of the arbitration phase 451 is carried out in the bit CRC-Del at the point marked SP in FIG. 2. SP stands for sample point.

The confirmation field 457 contains an ACK-Slot bit in which subscriber stations, which currently are only receivers of the frame 450 but not transmitters of the frame, can confirm or not confirm the correct reception of the frame 450 from the bus 40. The confirmation field 457 ends with an ACK-Del bit, which is also called ACK delimiter.

A bit sequence is provided in the frame end field EOF, which bit sequence marks the end of the frame 450. This means that the bit sequence of the end field (EOF) is used to mark the end of the frame 450. The end field (EOF), together with the ACK delimiter, ensures that a number of 8 recessive bits is transmitted at the end of the frame 450. This is a bit sequence that cannot occur within the frame 450. As a result, the end of the frame 450 can be reliably recognized by the subscriber stations 100, 101 . . . 10N and 30.

After the end field (EOF), which has 7 bits, an interframe space (IFS), not shown in FIG. 2, follows in the frame 450. In CAN FD, this interframe space (IFS) is designed in accordance with ISO11898-1:2015. The interframe space (IFS) has at least 3 bits.

Otherwise, the fields and bits mentioned are described in ISO11898-1:2015 and for this reason are not described in more detail here.

In the arbitration phase 451 of CAN FD, with the aid of the identifier (ID) with, for example, bits ID28 to ID0 in the arbitration field 453, negotiation takes place bit by bit between the subscriber stations 100 or other CAN FD subscriber stations on the bus 40 as to which subscriber station 100 wants to transmit the message 45 with the highest priority and will therefore receive exclusive access to the bus 40 of the bus system 1 for the near future for transmitting in the subsequent data phase 452. A physical layer such as in CAN and CAN FD is used in the arbitration phase 451. The physical layer corresponds to the bit transmission layer or layer 1 of the conventional OSI model (Open Systems Interconnection Model).

The subscriber stations 101 . . . 10N as CAN XL Light responder subscriber stations, more precisely their communication control device 21, do not support arbitration, as mentioned above and as described in more detail below. If there is no subscriber station 30 on the bus 40, but only a commander and its responder, no arbitration takes place on the bus 40.

In order to manage without CAN arbitration, in which the well-conventional CSMA/CR method resolves a collision if two CAN nodes (subscriber stations) start a message at the same time, the commander must specify when which responder is allowed to transmit a message. This means that if the commander has requested, via a transmission request, a specific responder to transmit, the commander will wait for a time, specified by the user, until the responder has responded before the commander transmits any other message. If a responder that has received a transmission request but has not yet started its response sees the start of another message on the CAN bus 40, it considers its transmission request as completed and does not transmit its message 46. The response times of the various responders in the CAN system are known to the commander.

Collisions of frames on the bus 40 between CAN XL Light responders (subscriber stations 101 . . . 10N) and possibly other CAN nodes, such as the subscriber station 30, which contain the arbitration function, can also be avoided as follows. For this purpose, the responders are assigned identifiers with a higher arbitration priority for transmission. As a result, if the other subscriber stations start a message at the same time as a responder, they will lose the arbitration and become the receiver.

The subscriber station 100 as the transmitter of a message 45, 46 begins transmitting bits of the data phase 452 to the bus 40 only if the subscriber station 100 as the transmitter has won the arbitration and the subscriber station 100 as transmitter thus has exclusive access to the bus 40 of the bus system 1 for transmission. The same applies to each CAN subscriber station 30 that is connected to the bus 40 and wants to transmit a message 45, 46 to the bus 40.

FIG. 3 shows, for the message 46, a CAN XL frame 460, as is provided by a subscriber station 100 or a subscriber station (responder) 101 . . . 10N or their communication control device 21, namely encoded in a digital transmission signal TxD, for the associated transmitting/receiving device 11, 22 for transmission to the bus 40. Here, the communication control device 21 creates the frame 460 in the present exemplary embodiment as compatible with CAN FD, as also illustrated in FIG. 3.

According to FIG. 3, the CAN XL frame 460 is divided for CAN communication on the bus 40 into different communication phases 451, 452, namely the arbitration phase 451 and the data phase 452. Following a start bit (SOF), the frame 460 has an arbitration field 463, a control field 464 with an ADS field for switching between the communication phases 451, 452, a data field 465, a checksum field 466, and also a frame termination field 467. This is followed by the frame end field EOF, as in the case of a frame 450 according to FIG. 2. The CAN XL format is specified in ISO/DIS11898-2:2023.

In the arbitration phase 451, arbitration is also carried out for the frame 460 of FIG. 3 with the aid of the identifier (ID), as described above with reference to FIG. 2 for the various bus configurations. In the arbitration phase 451, an arbitration bit rate less than or equal to 1 Mbit/s is used with the present exemplary embodiment. If there is no subscriber station 30 on the bus 40, no arbitration takes place on the bus 40.

According to FIG. 3, in the data phase 452, in addition to a portion of the control field 464 of the frame 460, the payload data of the CAN XL frame 460 or of the message 46 are transmitted from the data field 465 and the checksum field 466. In the data phase 452, in the present exemplary embodiment, a data bit rate is used which can have values of in particular up to 20 Mbit/s.

After the data phase 452, in the case of CAN XL according to FIG. 3, the DAS field follows, which is used for switching from the data phase 452 back to the arbitration phase 451.

In the CAN XL data phase 452, 40 symmetrical ‘1’ and ‘0’ levels can be used for the transmission on the bus, rather than recessive and dominant levels as with CAN FD, provided that the corresponding transmitting/receiving devices for CAN XL are used.

In general, two different stuffing rules are applied in the generation of the frame 460. The dynamic bit stuffing rule of CAN FD applies up to the FDF bit in the arbitration field 453 or for a frame 450 of FIG. 2 so that, after 5 identical bits in succession, a stuff bit inverse thereto is to be inserted. In the data phase 452 up to the FCP field, a fixed stuffing rule applies so that a fixed stuff bit that is inverse to the preceding bit is to be inserted after a fixed number of bits.

In the present exemplary embodiment, the res bit described in CAN FD, which is denoted by the XLF bit in the frame 460, is used for switching from the CAN FD format to the CAN XL format. For this reason, the frame formats of CAN FD and CAN XL are identical up to the res bit or XLF bit. Only at this bit does a receiver recognize the format in which the frame 460 is transmitted. If the bit is transmitted as 1, i.e., recessive, it is the XLF bit and thus identifies the frame 460 as a CAN XL frame. For a CAN FD frame of FIG. 2, the communication control device 11, 31 sets the bit as 0, i.e., as a dominant res bit. A CAN XL subscriber station, that is to say in this case the subscriber stations 30, 100, also supports CAN FD. The subscriber stations 101 . . . 10N, on the other hand, are designed for CAN XL Light and only support frame 460 (CAN XL format) when transmitting and receiving.

The XLF bit is followed in the frame 460 by a resXL bit, which is a dominant bit for future use. The resXL must be transmitted for the frame 460 as 0, i.e., dominant.

The resXL bit is followed in the frame 460 by a sequence ADS (arbitration data switch) in which a predetermined bit sequence is encoded. This bit sequence permits simple and reliable switching from the bit rate of arbitration phase 451 (arbitration bit rate) to the bit rate of the data phase 452 (data bit rate). Optionally, within the ADH bit, the operating mode of the transmitting/receiving device 12, 22, 32 is switched from the operating mode B_451 (SLOW or SIC) of the arbitration phase 451 to one of two operating modes B_452_TX (FAST_TX), B_452_RX (FAST_RX) of the data phase 452. The two operating modes of the data phase 452 are an operating mode B_452_TX (FAST_TX) for a transmitting node that is allowed to transmit its signal to the bus 40 in the data phase 452, and an operating mode B_452_RX (FAST_RX) for a receiving node which is only the receiver of the signal from the bus 40. In order to achieve data bit rates of up to 20 Mbit/s, the physical layer, i.e., the operating mode of the transmitting/receiving device 12, 22, 32, is switched from SLOW or SIC to FAST_TX or FAST_RX within the ADH bit. The switching of the physical layer is necessary if data bit rates of more than 8 Mbit/s are required or if a complex CAN bus topology is used, which is the case with long branch lines, for example.

Subsequent fields up to the beginning of the data field 465 are not described in more detail here. The data field 465 can have up to 2048 bytes. The length of the data field 465 is encoded in bits 0 to 10 of the DLC field.

The data field 465 is followed in the frame 460 by the checksum field 466 with a frame checksum FCRC and an FCP field. Here, FCP=frame check pattern. The FCP field consists of 4 bits with in particular the bit sequence 1100. A receiving node uses the FCP field to check whether the receiving node is bit-synchronous with the transmission data stream. In addition, a receiving node synchronizes to the falling edge in the FCP field.

The FCP field is followed by the frame termination field 467. The frame termination field 467 consists of two fields, namely the DAS field, and the confirmation field or ACK field with the at least one ACK bit and the ACK-Dlm bit.

The DAS field contains the DAS sequence (data arbitration switch) in which a predetermined bit sequence is encoded. This DAH, AH1, AL1 bit sequence permits simple and reliable switching from the data bit rate of the data phase 452 to the arbitration bit rate of the arbitration phase 451. In addition, during the DAS field, more precisely in the DAH bit, the operating mode of the transmitting/receiving device 12, 22, 32 is optionally switched from a B_452_TX (FAST_TX) or B_452_RX (FAST_RX) operating mode to a B_451 (SLOW or SIC) operating mode. If the physical layer was previously switched, the physical layer is switched within the DAH bit. The AH1 bit is followed by the AL1 bit (logical 0) and the AH2 bit (logical 1). The two bits DAH and AH1 ensure that there is enough time for the operating mode switching of the transmitting/receiving device 11, and that all subscriber stations 30, 100, 101, to 10N see a recessive level of significantly more than one arbitration bit time before the edge at the beginning of the AL1 bits (logical 0). This ensures reliable synchronization for the subscriber stations of the bus system.

In the frame termination field 467, the sequence of the DAS field is followed by the confirmation field (ACK). In the confirmation field, bits are provided for confirming or not confirming a correct reception of the frame 460.

In the frame 460, the frame termination field 467 is followed by the frame end field (EOF=end of frame), as in the case of CAN FD according to FIG. 2.

For subscriber stations whose error signaling is not activated and which transmit a CAN XL frame, the frame end field (EOF) has a length which is different depending on whether a dominant bit or a recessive bit has been seen in the ACK bit. If the transmitting subscriber station has received the ACK bit as dominant, the frame end field (EOF) has a number of 7 recessive bits. Otherwise, the frame end field (EOF) is only 5 recessive bits long.

In the frame 450, the frame end field (EOF) is followed by an interframe space (IFS), as explained above with respect to the frame 450 of FIG. 2.

The following applies to CAN XL.
In contrast to CAN FD, the identifier ID of the frame 460 is called “Priority ID” in the case of CAN XL.
In contrast to CAN FD, CAN XL can transmit the RRS bit as (logical) 0 or as (logical) 1. In CAN FD, the RRS bit is always transmitted as logical 0.

FIG. 4 shows the basic structure of the subscriber station 100 with the communication control device 11, the transmitting/receiving device 12, and the synchronization module 15, which is part of the communication control device 11.

According to FIG. 4, the subscriber station 100 (commander) has, in addition to the communication control device 11 and the transmitting/receiving device 12, a microcontroller 13 to which the communication control device 11 is assigned, and a system ASIC 16 (ASIC=application-specific integrated circuit). The system ASIC 16 can alternatively be a system basis chip (SBC) on which a plurality of functions necessary for an electronics assembly of the subscriber station 100 are combined. The system ASIC 16 in particular has an application 161, which can be designed as a computer program (app) or software. Such an application is a technical application 161. The application 161 is, for example, any application in a vehicle. In particular, the application is a windshield washer system and/or a driver assistance system, etc. For example, the windshield washer system controls the movement of at least one windshield wiper (actuator) using data from a rain sensor and/or wind sensor and/or speed sensor and/or light sensor, and/or a warning light (actuator) can be switched on or off. However, the application is not limited to a windshield washer system or parts thereof.

In the system ASIC 16, a power supply device 17 which supplies the transmitting/receiving device 12 with electrical energy is installed in addition to the transmitting/receiving device 12. The power supply device 17 usually supplies a voltage CAN_Supply of 5 V. Depending on requirements, however, the power supply device 17 can provide a different voltage with a different value. Additionally or alternatively, the power supply device 17 can be designed as a current source.

If the communication control device 11 acts as a CAN XL Light commander, the communication control device 11 creates a frame 460, in which bit rate switching can take place in the fields ADS, DAS of FIG. 3, as described above, and/or evaluates such a frame 460. For this purpose, a standard CAN XL communication control device according to ISO/DIS 11898-1:2023 can be used for the device 11. As a result, a data bit rate with values of in particular up to 20 Mbit/s can be achieved in the data phase 452. With the communication control device 11 as CAN XL Light commander, the bit rate switching can be switched on or off. Switched off means that the user sets the same bit rate for the arbitration phase 451 and the data phase 452.

According to FIG. 4, the synchronization module 15 has a synchronization block 151, optionally a configuration block 152, optionally an evaluation block 153 and a switching block 154. In particular, a value for at least one synchronization configuration bit 1521 can be stored in the optional configuration block 152. The synchronization block 151 can be the bit timing control unit BTL of the communication control device 11.

The synchronization module 15, in particular the evaluation block 153 and the switching block 154, can be designed at least partially as software.

The synchronization block 151 has a synchronization function described in ISO/DIS11898-2:2023. However, this synchronization function can be switched as required, as described in more detail below.

The transmitting/receiving device 12 has a transmitting module 121 and a receiving module 122. Although reference is always made to the transmitting/receiving device 12 below, it is alternatively possible to provide the receiving module 122 in a separate device externally from the transmitting module 121. The transmitting module 121 and the receiving module 122 can be constructed as in a conventional CAN-SIC-XL transmitting/receiving device 12. The transmitting module 121 can in particular have at least one operational amplifier and/or a transistor. The receiving module 122 can in particular have at least one operational amplifier and/or a transistor.

The transmitting/receiving device 12 is connected to the bus 40, more specifically its first bus wire 41 for CAN_H and its second bus wire 42 for CAN_L. The voltage supply for the power supply device 17 for supplying the first and second bus wires 41, 42 with electrical energy, in particular with the voltage CAN-Supply, is effected via at least one terminal 43. The connection to ground or CAN_GND is realized via a terminal 44. The first and second bus wires 41, 42 are terminated with a terminating resistor 49.

In the transmitting/receiving device 12, the first and second bus wires 41, 42 are connected not only to the transmitting module 121, which is also referred to as a transmitter, but also to the receiving module 122, which is also referred to as a receiver, although the connections are not shown in FIG. 4 for the sake of simplicity.

During operation of the bus system 1, the transmitting module 121 of FIG. 4 can serially convert a transmission signal TxD of the communication control device 11, for example the transmission signal TxD of FIG. 5, into corresponding signals CAN_H, CAN_L for CAN or CAN FD or CAN XL for the bus wires 41, 42 and transmit these signals to the bus 40 at the terminals for CAN_H and CAN_L.

The communication control device 11 transmits the transmission signal TxD of FIG. 5 over time t (serially) via the terminal TXD to the transmitting module 121, as shown in FIG. 4. As shown as an example in FIG. 5, the transmission signal TxD has the voltage states H (high) and L (low) with a corresponding voltage U.

According to the example of FIG. 6, the signals CAN_H and CAN_L for a frame 450 of FIG. 2 or frame 460 of FIG. 3 (without operating mode switching of the transmitting/receiving device) in the arbitration phase 451 have the dominant and recessive bus levels 401, 402, as described in CAN. A difference signal VDIFF=CAN_H−CAN_L, which is shown in FIG. 7 for the arbitration phase 451, is formed on the bus 40. The individual bits of the VDIFF signal with the bit time t_bt1 can be recognized in the arbitration phase 451 and the data phase 452 with a reception threshold T_a of, for example, 0.7 V. In the data phase 452 of a frame 450, the bits of the signals CAN_H and CAN_L can be transmitted faster, that is to say with a shorter bit time t_bt2, than in the arbitration phase 451, as described above. In CAN FD for the frame 450 or CAN XL for the frame 460, the signals CAN_H and CAN_L thus differ in the data phase 452 from the conventional signals CAN_H and CAN_L, at least in their faster bit rate.

The sequence of the states H, L of the transmission signal TxD of FIG. 5 and the resulting states 401, 402 for the signals CAN_H, CAN_L in FIG. 6 along with the resulting profile of the voltage VDIFF of FIG. 7 are used only to illustrate the function of the subscriber station 100. The sequence of the data states for the bus states 401, 402 can be selected as required.

The receiving module 122 forms a reception signal RxD from the signals CAN_H and CAN_L received from the bus 40, which are shown in FIG. 6, or the differential voltage VDIFF of FIG. 7. For generating the digital reception signal RxD of FIG. 8, the receiving module 122 uses the reception thresholds T_A, etc., as described above. The reception signal RxD is shown in FIG. 8 without propagation delay. The receiving module 122 forwards this reception signal RxD to the associated communication control device 11, as shown in FIG. 4.

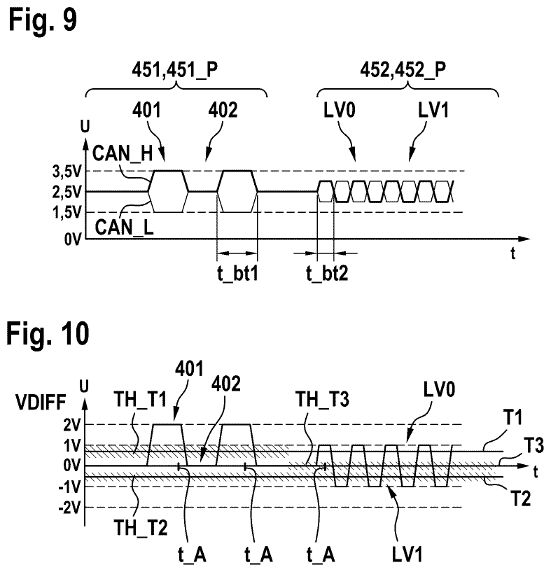

If a CAN XL-capable subscriber station 30, 100, 101, . . . , 10N uses the operating mode switching of the transmitting/receiving device 12, 22, 32, which can be switched on/off via configuration according to ISO/DIS11898-1:2023, then for a message 46 based on a frame 460 of FIG. 3, the signals of FIG. 9 and FIG. 10 apply instead of the signals of FIG. 6 and FIG. 7.

As shown in FIG. 9, in the arbitration phase 451, the transmitting/receiving devices 12, 22, 32 use a first physical layer 451_P to transmit to the bus 40 a transmission signal TxD (FIG. 5) over time t as signals CAN_H, CAN_L. In contrast, in the data phase 452, the transmitting/receiving device 12, 22, 32 can use a second physical layer 452_P, which is different from the first physical layer 451_P, for data bit rates of up to 20 Mbit/s in order to transmit to the bus 40 the transmission signal TxD (FIG. 1) as signals CAN_H, CAN_L, as described above. There are two operating modes for the physical layer 452_P, namely FAST_TX and FAST_RX, as described above.

FIG. 9 shows on the left side that, in the arbitration phase 451, the subscriber stations 30, 100, 101, . . . , 10N each transmit transmission signals CAN_H, CAN_L, which have a first bit duration t_bt1, over time t to the bus 40. The signals CAN_H, CAN_L are serial signals and alternately have at least one dominant state 401, in which, at a supply voltage VCC=5 V, VCAN_H=3.5 V and VCAN_L=1.5 V, or at least one recessive state 402, in which VCAN_H=VCAN_L=2.5. A dominant state 401 (dom) is driven in phase 451 during NRZ encoding of the transmission signal TXD if TXD=0 or LOW (LOW) (FIG. 5). A recessive state 402 (rec) is generated or occurs during NRZ encoding of the transmission signal TXD in phase 451 if TXD=1 or HI (HIGH) (FIG. 5). After the arbitration in the arbitration phase 451, i.e., if an arbitration takes place between subscriber stations 30 and 100, one of the subscriber stations 30, 100 is determined as the winner.

If the communication control device of the particular subscriber station 30, 100, 101, . . . , 10N starts the signaling in the first switching field ADS of FIG. 3 for the switching from the first to the second communication phase 451, 452, the associated transmitting/receiving device 12, 22 switches its physical layer 451_P at the end of the arbitration phase 451 from a first operating mode (SLOW), which can alternatively be designed as a SIC operating mode, to the physical layer 452_P of the data phase 452. For this purpose, the operating modes of the data phase 452 are switched on, as described above with reference to FIG. 3.

As shown on the right side in FIG. 9, in the data phase 452 or in the second operating mode (FAST_TX), the transmitting module 121 then, depending on a transmission signal TxD, generates the states LV0 or LV1 with the physical layer 452_P for the signals CAN_H, CAN_L on the bus 40 one after the other and thus serially. The state LV0 (VCAN_H=3.0 V, VCAN_L=2.0 V) is driven during a pulse width modulation (PWM encoding) of the transmission signal TxD for a first PWM symbol in the transmission signal TXD. The state LV1 (VCAN_H=2.0 V and VCAN_L=3.0 V) is driven in the transmission signal TXD during the pulse width modulation (PWM encoding) of the transmission signal TXD for a second PWM symbol which is different from the first PWM symbol.

The frequency of the signals CAN_H, CAN_L can be increased in the data phase 452. For this purpose, in the example in FIG. 9, the bit time or bit duration t_bt2 in the data phase 452 is shorter or less than the bit time or bit duration t_bt1 in the arbitration phase 451. In the example in FIG. 9, the net data transmission rate in the data phase 452 is thus increased compared to the arbitration phase 451.

In contrast, for example, the transmitting/receiving device 32 of the subscriber station 30 switches its physical layer 451_P at the end of the arbitration phase 451 from the first operating mode (SLOW or SIC) to the physical layer 452_P of the data phase 452 for a third operating mode (FAST_RX) of the transmitting/receiving device 12 since, in the data phase 452, the subscriber station 30 is only a receiver, i.e., not a transmitter, of the frame 450. The same applies to the responder subscriber stations 101 . . . 10N. Each of the subscriber stations 30, 100, 101, . . . , 10N can transmit and receive. In this example, it is only assumed that subscriber stations 30 and 101, . . . , 10N are receivers of the currently transmitted frame.

If the transmitting/receiving device 12, in particular with the signaling in the second switching field DAS of FIG. 3, recognizes that switching from the data phase 452 back to the arbitration phase 451 is to be made, the transmitting/receiving device 12 will be switched from transmitting (operating mode FAST_TX) (and)or receiving (operating mode FAST_RX) signals with the physical layer 452_P to transmitting and/or receiving signals with the physical layer 451_P. Thus, after the end of the data phase 452, all transmitting/receiving devices 12, 22, 32 switch their operating mode to the first operating mode (SLOW or SIC). All transmitting/receiving devices 12 can thus not only switch between the bit durations t_bt1, t_bt2 but also switch their physical layer, as described above.

According to FIG. 10, in the arbitration phase 451, in the ideal case, a difference signal VDIFF=CAN_H−CAN_L with values of VDIFF=2 V for dominant states 401 (dom) and VDIFF=0 V for recessive states 402 (rec) is formed over time t on the bus 40. The profile of VDIFF in phase 451 is shown on the left side in FIG. 10. In contrast, in the data phase 452, a difference signal VDIFF=CAN_H−CAN_L corresponding to the states LV0, LV1 in FIG. 10 is formed over time t on the bus 40, as shown on the right-hand side in FIG. 10. The state LV0 has a value VDIFF=1 V. The state LV1 has a value VDIFF=−1 V.

The receiving module 122 can distinguish the states 401, 402 with in each case one of the reception thresholds T1, T2, T3, which are in the ranges TH_T1, TH_T2, TH_T3. For evaluating the signals from the bus 40, the receiving module 122 uses the reception threshold T1 of, for example, 0.7 V, which can be equal to the reception threshold T_a in FIG. 7, in the arbitration phase 451 to generate the reception signal RxD, and optionally the reception threshold T2 of, for example, −0.35 V. In contrast, for evaluating the signals from the bus 40, the receiving module 122 uses the reception threshold T3 in the data phase 452 to generate the reception signal RxD. When switching between the first to third operating modes (SLOW or SIC, FAST_TX, FAST_RX) described above with reference to FIG. 9, the receiving module 122 switches in each case the reception thresholds T2, T3, as shown in FIG. 10.

The reception thresholds T1 and T2 are used for recognizing whether the bus 40 is free, if the subscriber station 12 is newly connected to the communication on the bus 40 and attempts to integrate itself into the communication on the bus 40.

When receiving the corresponding signals from the bus 40, each transmitting/receiving device 12 generates the associated reception signal RxD, as shown in FIG. 8. Ideally, the reception signal RxD has no time offset from the transmission signal TxD.

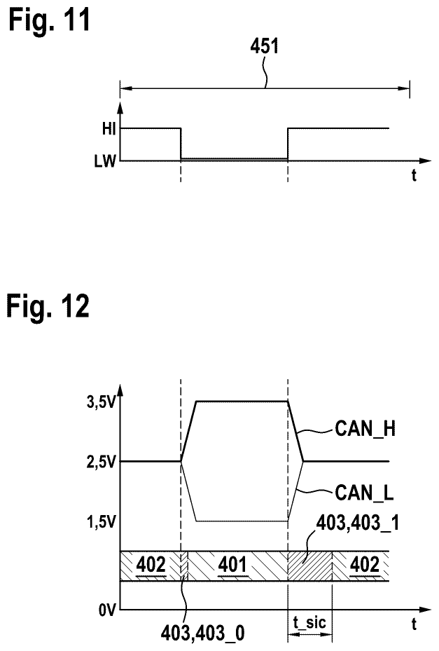

As shown in more detail in FIG. 11 and FIG. 12, for the transmission signal TxD of FIG. 11, the transmitting module 121 in the first operating mode (SLOW or SIC) generates the signals CAN_H, CAN_L according to FIG. 12 for the bus wires 41, 42 in such a way that a state 403 (sic) is additionally present. The state 403 (SIC) can have different lengths, as shown with the state 403_0 (sic) during the transition from the state 402 (rec) to the state 401 (dom) and with the state 403_1 (sic) during the transition from the state 401 (dom) to the state 402 (rec). The state 403_0 (sic) is shorter in time than the state 403_1 (sic). In order to generate signals according to FIG. 12, the transmitting module 121 is switched to the first operating mode (SLOW or SIC).

Passing through the short sic state 403_0 is not required in ISO/FDIS11898-2:2023, and the state is dependent on the type of implementation. The duration of the “long” state 403_1 (sic) is specified for the first operating mode (SLOW or SIC) as t_sic<530 ns, starting with the rising edge at the transmission signal TxD of FIG. 11.

The subscriber station 100 is thus designed like a conventional CAN XL subscriber station. The user ensures, through the configuration of the data field and/or the selection of the identifiers (ID) of the subscriber stations 100 (commander) and the subscriber stations 101 . . . 10N, that the subscriber station 100 operates as a CAN XL Light commander and the subscriber stations 101 . . . 10N operate as CAN XL Light responders according to the polling principle. Accordingly, the subscriber station 100 (commander) can transmit messages 46 to each of the subscriber stations 101 . . . 10N (responders). The subscriber station 100 (commander) encodes in the message whether or not the responder is to respond. The responder may not transmit a message without a prior request.

Optionally, however, the subscriber station 100 (commander) can proceed as follows.

During operation of the bus system 1, the subscriber station 100 (commander), more precisely the communication control device 11, performs bus monitoring. According to ISO 11898-1:2015, the subscriber station 100, in particular the communication control device 11, compares its own bits, transmitted according to a frame 450, 460 and a transmission signal TxD (FIG. 5), at the sample point AP with the bits, observed on the bus 40, according to the reception signal RxD (FIG. 8). A difference is considered an error, except in the case of arbitration and the ACK bit.

However, the subscriber station 100 (commander), more precisely the communication control device 11, switches off the bus monitoring for short bit times t_bt1, t_bt2 according to the preset configuration via software, if the subscriber station 100 (commander) is the transmitter of the message 46. The short bit rates can be present in the arbitration phase 451 and/or the data phase 452. Such short bit times occur at bit rates above 1 Mbit/s, at which the so-called loop delay of the subscriber station 100 (CAN node) comes into the range of half a bit time t_bt1, t_bt2 or more. The so-called loop delay indicates the time that elapses until the subscriber station 100 can internally see the bit of the transmission signal TxD, transmitted via the terminal TXD, as the reception signal RxD.

In addition, during operation of the bus system 1, the subscriber station 100 (commander), more precisely the communication control device 11, performs a synchronization function with the synchronization block 151 for all frames 460 that the subscriber station 100 (commander) transmits to one of the responders 101 . . . 10N, and in which frames 460 the bits have a bit time t_bt1, t_bt2 for bit rates up to 1 Mbit/s.

The synchronization block 151 observes the edges from recessive to dominant or vice versa, i.e., a change between the states 401, 402 or 402, 401 in FIG. 6 or FIG. 7 or FIG. 9 and FIG. 10. The synchronization block 151 synchronizes the position t_A of the sample point AP within a bit time t_bt1 based on the observed edges (FIG. 9 and FIG. 10). A receiver synchronizes itself in this way to the transmitter of a frame 450, 460. If an edge ideally occurs at the beginning of a bit time t_bt1, t_bt2, no synchronization is necessary, because there are edge changes at the beginning of a bit time. If an edge occurs between the beginning of a bit time t_bt1, t_bt2 and the sample point, a so-called late edge occurs. This causes a synchronization with which the current bit time t_bt1, t_bt2 is extended. If an edge occurs between the sample point AP and the end of a bit time t_bt1, t_bt2, a so-called early edge occurs. This causes a synchronization with which the current bit time t_bt1, t_bt2 is shortened.

According to ISO 11898-1:2015, the transmitters of a frame 450, 460 also synchronize. However, the restriction applies that a subscriber station 100 that transmits a dominant bit does not synchronize to late edges. The reason for this is that the transmitter sees all the bits it has transmitted late due to the “loop delay.” Therefore, synchronization to these late edges, which were transmitted by the subscriber station itself, would extend these bits and distort the bit rate. The permitted synchronization to “early edges” stabilizes the CAN arbitration at the beginning of the frame 450, 460. This is in particular necessary if arbitration takes place.

The synchronization function is described in more detail in ISO 11898-1:2015.

However, with the synchronization module 15, the synchronization function of the synchronization block 151 can be switched as required, as described below.

The evaluation block 153 is designed to evaluate the synchronization configuration bit 1521 in the configuration block 152. The synchronization configuration bit 1521 is set if the subscriber station 100 (commander), more precisely the communication control device 11, is to transmit the frame 460 with a bit time t_bt1 of the first communication phase 451 that corresponds to a bit rate that is greater than a predetermined bit rate. In particular, the predetermined bit rate is greater than 1 Mbit/s.

If the evaluation of the evaluation block 153 shows that the synchronization configuration bit 1521 is set, the evaluation block 153 checks whether the subscriber station 100 (commander), more precisely the communication control device 11, is to (currently) act as a transmitter, i.e., is to transmit a frame 460 to a responder to the bus 40. For example, the synchronization configuration bit 1521 is set together with the bit rate configuration, either by software or in a hardwired manner. During operation of the bus system 1, configuration bit 1521 is then constant.

If the evaluation of the evaluation block 153 shows that the subscriber station 100 (commander), more precisely the communication control device 11, is to act as a transmitter and to transmit a frame 460 to a responder to the bus 40, the evaluation block 151 instructs the switching block 154 to switch off the synchronization block 151. The switching block 154 thus switches the synchronization block 151 and thus its above-described synchronization function off or on for all bits of the frame 460 to be transmitted by the subscriber station 100 as commander to the bus 40, up to the last bit of the end field (EOF).

Due to the switching off of the synchronization block 151, the transmitter is prevented from synchronizing itself to its own transmitted edges, which it does not see within the transmitted bit, but in one of the subsequent bit times. Synchronization can be switched off because arbitration cannot occur because arbitration is no longer possible at this bit rate t_b1 of over 1 Mbit/s.

After the last bit of the end of field (EOF) of the transmitted frame, the switching block 154 of FIG. 4 switches the synchronization block 151 and thus its above-described synchronization function back on.

In addition, the necessity to transmit an acknowledgment response (ACK bit or ACK response) for a message 46 from a responder (subscriber station 101 . . . 10N) can be deactivated at the subscriber station 100 (commander). In addition, with the subscriber station 100 (commander), the necessity to receive an acknowledgment response (ACK bit or ACK response) for a message 46 transmitted by it to a responder (subscriber station 101 . . . 10N) can be deactivated.

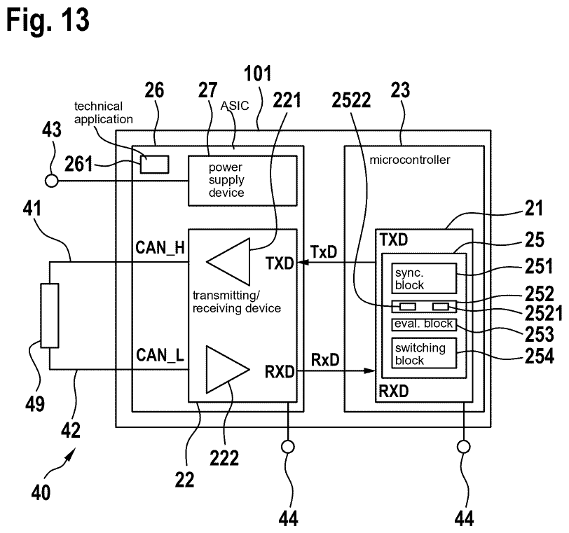

According to FIG. 13, the responder subscriber station 101 has, in addition to the communication control device 21 and the transmitting/receiving device 22, a simple control unit (FSM) or optionally a microcontroller 23, to which the communication control device 21 is assigned, and a system ASIC 26 (ASIC=application-specific integrated circuit), which can alternatively be a system basis chip (SBC) on which a plurality of functions necessary for an electronics assembly of the subscriber station 101 are combined. The system ASIC 26 in particular has an application 261, which can be designed as a computer program (app). Such an application is a technical application 261.

The application 261 is, for example, a control for a sensor or a transducer or an actuator or the like, which is controlled by the application 161 (FIG. 4) of the commander subscriber station 100 or is to provide data for the application 161.

The responders have little or no local computing power and can carry out simple functions, e.g., controlling light diode (LED) on/off, light diode (LED) color, as described above. A responder only transmits a CAN XL frame if it has been requested to do so by the commander through a transmission request. Thus, after a transmission request by the commander, the responder CAN subscriber stations (responders) transmit their function information, e.g., a sensor value, etc., via a CAN XL message to the commander CAN subscriber station (commander).

According to FIG. 13, in the system ASIC 26, a power supply device 27, which supplies the transmitting/receiving device 22 with electrical energy, is installed in addition to the transmitting/receiving device 22. The power supply device 27 usually supplies a voltage CAN_Supply of 5 V. Depending on requirements, however, the power supply device 27 can provide a different voltage with a different value. Additionally or alternatively, the power supply device 27 can be designed as a current source.

The communication control device 21 creates a frame 460, in which bit rate switching or a bit rate change can be carried out, as described with reference to FIG. 3 and FIG. 4, and/or evaluates such a frame 460 based on the frame 460 received from the commander subscriber station 100. The communication control device 21 acts as a CAN XL Light responder. The devices 21, 22 can only transmit such a frame 460 to the bus 40 upon request from the commander subscriber station 100 (polling).

The transmitting module 221 of FIG. 13 is otherwise constructed in the same manner as described above for the transmitting module 121 of FIG. 4.

The synchronization module 25 of FIG. 13 has a synchronization block 251, a configuration block 252, an evaluation block 253, and a switching block 254. At least one configuration bit 2521, 2522 is stored in the configuration block 252.

The synchronization module 25 can also undertake the switching off of the synchronizations for frames 460 or messages 46 transmitted by the subscriber station 101, as described above with reference to FIG. 4 for the synchronization module 15 for the frames 450, 460. Accordingly, at high bit rates, the synchronization module 25 always switches off the synchronization for frames 460 or messages 46 transmitted by the subscriber station 101. The high bit rates are, for example, greater than 1 Mbit/s.

In contrast to the synchronization module 15 of FIG. 4, the synchronization module 25 of FIG. 13 is optionally designed to switch off the synchronization for frames 460 or messages 46 transmitted by the subscriber station 101, in the associated responder even at low bit rates if desired. For this purpose, an additional configuration bit 2522 can be set, for example. The low bit rates are, for example, less than or equal to 1 Mbit/s. This switching off does not have a major impact on the communication between commander subscriber station 100 and the particular responder subscriber station 101 . . . 10N.

As a result, it is possible to select that the synchronization module 25 of FIG. 13 is optionally designed to switch off its synchronization function for frames 460 or messages 46 transmitted by the subscriber station 101, both at a low and at a high bit rate. In other words, it is thereby possible to select that the synchronization module 25 of FIG. 13 is designed to switch off its synchronization function for frames 460 or messages 46 transmitted by the subscriber station 101, regardless of the bit rate.

The subscriber stations 101 . . . 10N can do without this synchronization, because with CAN XL Light or when communicating with the commander subscriber station 100, no arbitration takes place and, at higher bit rates, an ACK bit is also not transmitted.

The synchronization module 25 is otherwise constructed in the same way as described above for the synchronization module 15.

The synchronization modules 15, 25 thus ensure that communication with CAN XL Light is possible even at bit rates greater than or equal to 1 Mbit/s.

Thus, the subscriber stations 101 . . . 10N (responders) have a CAN XL Light protocol controller. The CAN XL implementation of the communication control device 21 is adjusted for this purpose. The adjustments aim to simplify or reduce functionality in order to reduce resource requirements. Among other things, the following adjustments are available, for example.

The bit monitoring when transmitting a message 46 is not present or is switched off in the communication control device 21. This is possible since CAN XL Light does not require arbitration and cannot transmit error frames. The lack of arbitration makes it possible to position the sample point AP or t_A according to FIG. 10 further into the middle of the bit and thus to allow a larger tolerance in the accuracy of the CAN clock. In addition, the “transmitter delay compensation” function can also be optimized away since it is only used for bit monitoring in the data phase and bit monitoring is no longer used.

In addition, with the communication control device 21, the signaling by means of error frames and overload frames is not present or is switched off. This is possible because, with CAN XL Light, immediate error signaling is not necessary.

In addition, the communication control device 21 does not perform automatic re-transmission. Since CAN XL Light cannot resolve collisions on the bus 40 by means of arbitration, a CAN XL Light subscriber station 101 . . . 10N (responder) may not automatically repeat the transmission of a message.

In addition, fault confinement can be omitted in the communication control device 21. CAN XL, CAN FD, and Classical CAN (CC) provide that a subscriber station on the CAN bus is automatically switched off if the subscriber station detects too many communication errors. This is to ensure that a faulty subscriber station does not interfere with the communication of other subscriber stations. Since, with CAN XL Light, the responder only transmits a frame 460 if requested to do so by the commander via frame 460, there is no need for the automatic switching off of the node.

Just as the communication control device 11 of the commander can be designed according to the description of FIG. 4, the communication control device 21 of the responder is also designed for high bit rates, namely greater than 1 Mbit/s, in the arbitration phase 451
not to transmit an ACK bit if the device 21 has correctly received a message 46, and
not to perform synchronization to the seen reception signal RxD (FIG. 8) while transmitting a frame 460.

However, in contrast to the communication control device 11 of the commander, the communication control device 21 of the responder is designed to support or transmit and/or receive only CAN frames in the XBFF format (XL base frame format).

Thus, a CAN XL Light responder can only transmit and receive frames in one format (XL), namely frame 460 according to FIG. 3.

Due to the limitation to a single frame format, the implementation effort of the CAN XL Light responder, in particular its communication control device 21, is significantly reduced.

According to a second exemplary embodiment, the communication control devices 11, 21 are set not to undertake switching of the operating mode of the transmission receiving devices 12, 22 between the arbitration phase 451 and the data phase 452 and back to the arbitration phase. Consequently, the operating mode switching of the transmitting/receiving devices 12, 22, in particular the switching of their physical layer, is switched off.

More specifically, the communication control devices 11, 21 are set to communicate with one another even without switching the bit rate. More precisely, the bit rate of the communication control devices 11, 21 is set as:

$$1 Mbit / s < arbitration bit rate t\_bt1 = data bit rate t\_bt2 <= 8 Mbit / s$$

With the second exemplary embodiment, the transmitter of a frame, be it the commander subscriber station 100 or the responder subscriber stations 101 . . . 10N, does not perform any bit monitoring or resynchronization to the reception signal RxD (FIG. 8).

As a result, in the CAN XL Light communication according to the present exemplary embodiment, only frames 460 without bit rate switching are used. This saves additional area of the ASCI 26 of the responder, and possibly also area of the ASCI 16 of the commander if the subscriber station 100 does not otherwise require the bit rate switching function. In addition, clock recovery from the CAN bit stream is made easier so that a quartz oscillator in the responder can be saved. This can further reduce the costs of the responder. Saving a quartz oscillator is also possible in the first exemplary embodiment.

In addition, the communication control devices 11, 21 can be set not to carry out arbitration in the CAN XL Light communication. The subscriber station 100 (commander) controls the communication in such a way that access conflicts on the bus 40 are avoided.

In this way, a cost-effective connection of responders to CAN bus systems can be carried out.

In all other respects, the same applies as described in relation to the first exemplary embodiment.

All above-described embodiments of the subscriber stations 100, 101 . . . 10N of the bus system 1 and the method carried out therein can be used individually or in all possible combinations. In particular, all features of the above-described exemplary embodiments and/or their modifications can be combined as desired. Additionally or alternatively, the following modifications are conceivable in particular.

Even if the present invention is described above using the example of the CAN bus system, the present invention can be used in any communication network and/or communication method in which two different communication phases are used in which the bus states generated for the different communication phases can be different.

In particular, the bus system 1 according to the exemplary embodiments can be a communication network in which data can be transmitted in series at two different bit rates. In the bus system 1, it must be ensured that exclusive, collision-free access of a subscriber station 100, 101 . . . 10N to a common channel is ensured at least for certain time periods.

In the exemplary embodiments, the number and arrangement of the subscriber stations 100, 101 . . . 10N in the bus system 1 is arbitrary. It is possible for one or more of the subscriber stations 100 to be present in the bus system 1. It is possible that more than one subscriber station 100 is present in the bus system 1, to which subscriber station at least one subscriber station 101 . . . 10N is assigned, as described above.

In order not to disturb an arbitration between the subscriber stations 100 on the bus 40, messages 46 from subscriber stations 101 . . . 10N (responders) therefore have an identifier (ID) with a higher priority than the identifier(s) (ID) of the subscriber station 100 or of any other CAN FD or CAN XL subscriber station.

In particular, only one subscriber station 100 (commander) and at least one subscriber station 101 . . . 10N (responder) are present.

It is conceivable that, in the subscriber stations 100, the module 15 is arranged separately from the communication control device 11. It is conceivable that, in at least one of the subscriber stations 100, 101 . . . 10N, the module 25 is arranged separately from the communication control device 21.

What is claimed is:

1. A responder subscriber station for a serial bus system, comprising:
a communication control device configured to control communication of the subscriber station with a commander subscriber station of the bus system and to evaluate at least one signal, received from a bus of the bus system, based on a predetermined frame, with which a bit time in a first communication phase can differ from a bit time in a second communication phase, wherein a field can be present in the frame for switching the first bit time and a first physical layer in a first communication phase to a second bit time and a second physical layer in a second communication phase; and
a synchronization module configured to synchronize the communication control device to the signal received from the bus;
wherein the synchronization module is configured to switch off its synchronization function when the communication control device is to act as a transmitter of the frame, so that the responder subscriber station is the transmitter of the signal received from the bus.

2. The responder subscriber station according to claim 1, wherein the synchronization module is configured to switch off its synchronization function when the bit time of the first communication phase of the predetermined frame (460) has a predetermined value corresponding to a bit rate greater than a predetermined bit rate, and when the communication control device is to act as a transmitter of the frame, so that the responder subscriber station is the transmitter of the signal received from the bus.

3. The responder subscriber station according to claim 2, wherein the synchronization module includes:
a synchronization block, which is configured for synchronizing the communication control device to the signal received from the bus, and
a configuration block, in which a value for at least one synchronization configuration bit stored, which value indicates whether the bit rate is greater than the predetermined bit rate.

4. The responder subscriber station according to claim 3, wherein the synchronization module further includes:
an evaluation block configured to evaluate the value of the at least one configuration bit, and
a switching block configured to switching on or off the synchronization of the synchronization block on based on the evaluation of the evaluation block.

5. The responder subscriber station according to claim 1, wherein the responder subscriber station is a subscriber station configured for communication according to CAN XL, and wherein the predetermined frame is a CAN XL frame in the XBFF format.

6. The responder subscriber station according to claim 2, wherein the predetermined bit rate is 1 Mbit/s.

7. A commander subscriber station for a serial bus system, comprising:
a communication control device configured to control communication of the subscriber station with a responder subscriber station of the bus system and to evaluate at least one signal, received from a bus of the bus system, based on a predetermined frame, with which a bit time in a first communication phase can differ from a bit time in a second communication phase, wherein a field can be present in the frame for switching a first physical layer in the first communication phase to a second physical layer in the second communication phase; and
a synchronization module configured to synchronize the communication control device to the signal received from the bus;
wherein the synchronization module is configured to switch off its synchronization function when the bit time of the first communication phase of the predetermined frame has a predetermined value corresponding to a bit rate that is greater than a predetermined bit rate and when the communication control device is to act as a transmitter of the predetermined frame, so that the commander subscriber station is a transmitter of the signal received from the bus.

8. The commander subscriber station according to claim 7, wherein the synchronization module includes:
a synchronization block, which is configured to synchronize the communication control device to the signal received from the bus, and
a configuration block, in which a value for at least one synchronization configuration bit is stored, which value indicates whether the bit rate is greater than the predetermined bit rate.

9. The commander subscriber station according to claim 8, wherein the synchronization module further includes:
an evaluation block configured to evaluate the value of the at least one configuration bit, and
a switching block configured to switch on or off the synchronization of the synchronization block based on the evaluation of the evaluation block.

10. The commander subscriber station according to claim 7, wherein the commander subscriber station is a CAN XL subscriber station, and wherein the predetermined frame is a CAN XL frame in the XBFF format.

11. The commander subscriber station according to claim 7, wherein the predetermined bit rate is 1 Mbit/s.

12. A bus system, comprising:
a bus; and
at least two subscriber stations, which are connected to one another via the bus in such a way that they can communicate with one another serially and of which one subscriber station is a commander subscriber station and at least one subscriber station is a responder subscriber station;
wherein each of the at least two subscriber stations also has a transmitting/receiving device configured to transmit a transmission signal to the bus of the bus system and/or to receive a signal from the bus of the bus system;
wherein the commander subscriber station includes:
a communication control device configured to control communication of the commander subscriber station with the responder subscriber station of the bus system and to evaluate at least one signal, received from a bus of the bus system, based on a predetermined frame, with which a bit time in a first communication phase can differ from a bit time in a second communication phase, wherein a field can be present in the frame for switching a first physical layer in the first communication phase to a second physical layer in the second communication phase, and
a synchronization module configured to synchronize the communication control device of the commander subscriber station to the signal received from the bus,
wherein the synchronization module is configured to switch off its synchronization function when the bit time of the first communication phase of the predetermined frame has a predetermined value corresponding to a bit rate that is greater than a predetermined bit rate and when the communication control device of the commander subscriber station is to act as a transmitter of the predetermined frame, so that the commander subscriber station is a transmitter of the signal received from the bus; and
wherein the responder subscriber includes:
a communication control device configured to control communication of the responder subscriber station with the commander subscriber station of the bus system and to evaluate at least one signal, received from a bus of the bus system, based on a predetermined frame, with which a bit time in a first communication phase can differ from a bit time in a second communication phase, wherein a field can be present in the frame for switching the first bit time and a first physical layer in a first communication phase to a second bit time and a second physical layer in a second communication phase, and
a synchronization module configured to synchronize the communication control device of the responder subscriber station to the signal received from the bus,
wherein the synchronization module of the responder subscriber station is configured to switch off its synchronization function when the communication control device of the responder subscriber station is to act as a transmitter of the frame, so that the responder subscriber station is the transmitter of the signal received from the bus.

13. The bus system according to claim 12, further comprising at least one third subscriber station, which is configured to transmit and/or receive signals based on a frame, wherein the at least one third subscriber station has a communication control device, which is configured to negotiate with the commander subscriber station in the first communication phase of the frame whether the third subscriber station or the commander subscriber station will receive at least temporarily exclusive, collision-free access to the bus in a subsequent second communication phase.

14. A method for communication in a serial bus system, wherein the method comprising providing a commander subscriber station and a responder subscriber station;
wherein the commander subscriber station includes:
a communication control device configured to control communication of the commander subscriber station with the responder subscriber station of the bus system and to evaluate at least one signal, received from a bus of the bus system, based on a predetermined frame, with which a bit time in a first communication phase can differ from a bit time in a second communication phase, wherein a field can be present in the frame for switching a first physical layer in the first communication phase to a second physical layer in the second communication phase, and
a synchronization module configured to synchronize the communication control device of the commander subscriber station to the signal received from the bus,
wherein the synchronization module is configured to switch off its synchronization function when the bit time of the first communication phase of the predetermined frame has a predetermined value corresponding to a bit rate that is greater than a predetermined bit rate and when the communication control device of the commander subscriber station is to act as a transmitter of the predetermined frame, so that the commander subscriber station is a transmitter of the signal received from the bus; and
wherein the responder subscriber includes:
a communication control device configured to control communication of the responder subscriber station with the commander subscriber station of the bus system and to evaluate at least one signal, received from a bus of the bus system, based on a predetermined frame, with which a bit time in a first communication phase can differ from a bit time in a second communication phase, wherein a field can be present in the frame for switching the first bit time and a first physical layer in a first communication phase to a second bit time and a second physical layer in a second communication phase, and
a synchronization module configured to synchronize the communication control device of the responder subscriber station to the signal received from the bus,
wherein the synchronization module of the responder subscriber station is configured to switch off its synchronization function when the communication control device of the responder subscriber station is to act as a transmitter of the frame, so that the responder subscriber station is the transmitter of the signal received from the bus.

15. The method according to claim 14, wherein, in contrast to a CAN XL subscriber station:
the commander subscriber station and the responder subscriber station do not carry out bit monitoring when transmitting a message,
the commander subscriber station does not transmit an ACK bit when the commander subscriber station has correctly received a message,
the responder subscriber station does not transmit an ACK bit when the responder subscriber station has correctly received a message,
the responder subscriber station does not carry out error signaling,
the responder subscriber station does not use overload frames,
the responder subscriber station does not perform automatic re-transmission, and
the responder subscriber station does not perform automatic switching off of the responder subscriber station when detecting a predetermined number of communication errors.
